(19) United States
(12) Patent Application Publication
(10) Pub. No.: US 2016/0379134 A1
(43) Pub. Date: Dec. 29, 2016

(54) CLUSTER BASED DESKTOP MANAGEMENT SERVICES

(71) Applicant: International Business Machines Corporation, Armonk, NY (US)

(72) Inventors: Andrzej Kochut, Croton on Hudson, NY (US); Steven J. Mastrianni, Unionville, CT (US); Anca Sailer, Scarsdale, NY (US); Charles O. Schulz, Ridgefield, CT (US)

(21) Appl. No.: 14/749,021

(22) Filed: Jun. 24, 2015

(51) Int. Cl. G06N 99/00; G06N 5/04

(52) U.S. Cl. CPC G06N 99/005; G06N 5/04

(57) ABSTRACT

Historical data and real-time data are collected for a plurality of computing resources. Based on the collected historical data, typical behavior of the plurality of computing resources is modeled and resulting models are stored in a model repository. With an inference engine, the real-time data is compared to the models. The plurality of computing resources are managed based on the comparing step.

### STATEMENT OF GOVERNMENT RIGHTS

Not Applicable.

### CROSS-REFERENCE TO RELATED APPLICATIONS

Not Applicable.

### FIELD OF THE INVENTION

The present invention relates to the electrical, electronic and computer arts, and, more particularly, to service technologies and application-specific/industry-specific solutions.

### BACKGROUND OF THE INVENTION

Currently, large deployments of desktop computer resources require increasing amounts of labor to manage them. Patches, incidents and the like are handled in a case-by-case reactive manner for desktop consumers across industries including the financial, education, and government sectors. Today, while desktop management services provide automation support in virtualized environments, large deployments of traditional desktops are still high labor consumers and asset management tools are not aligned with the information technology (IT) view of those assets, including, for example, the configuration, usage models, and similarities between the organizations. Therefore, the labor costs for desktop deployment and maintenance are very high.

### SUMMARY OF THE INVENTION

Principles of the invention provide techniques for cluster based desktop management services. In one aspect, an exemplary method includes the step of collecting historical data about a plurality of computing resources; collecting real-time data about the plurality of desktop computing resources; based on the collected historical data, modeling typical behavior of the plurality of desktop computing resources and storing resulting models in a model repository; with an inference engine, comparing the real-time data to the models; and managing the plurality of desktop computing resources based on the comparing step.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one, some, or all of the following:
Enables identification of desktop classes with similar characteristics given a management aspect, i.e. deployment, patching, incident and problem management;
Reduces the labor required to manage large deployments of desktops by enabling automation of common tasks;
Enables target patches for dynamically identified desktops matching existing problems;
Less error prone;
Suitable for and provides leverage in the context of cloud environments.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an exemplary on-line IT (information technology) analytics managed system for classes-based management, according to an embodiment of the present invention;

FIG. 5 depicts the data acquisition subsystem of FIG. 4 in more detail, according to an embodiment of the present invention; and

FIG. 6 depicts a workflow chart of the system of the present invention, according to an embodiment of the present invention.

### DETAILED DESCRIPTION OF PREFERRED EMBODIMENTS

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

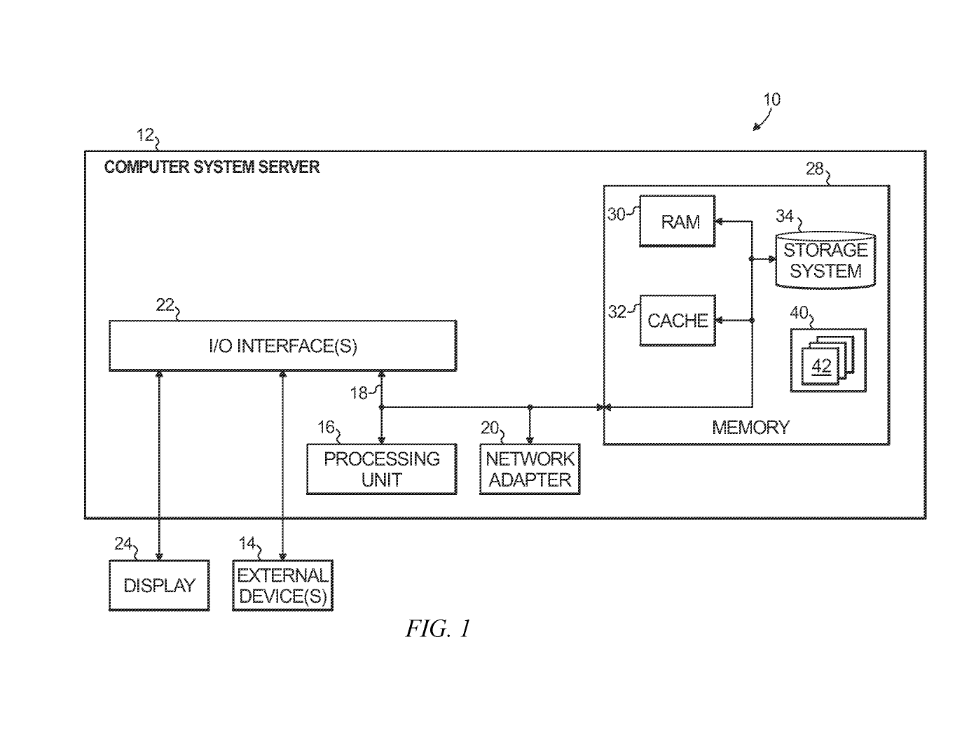

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

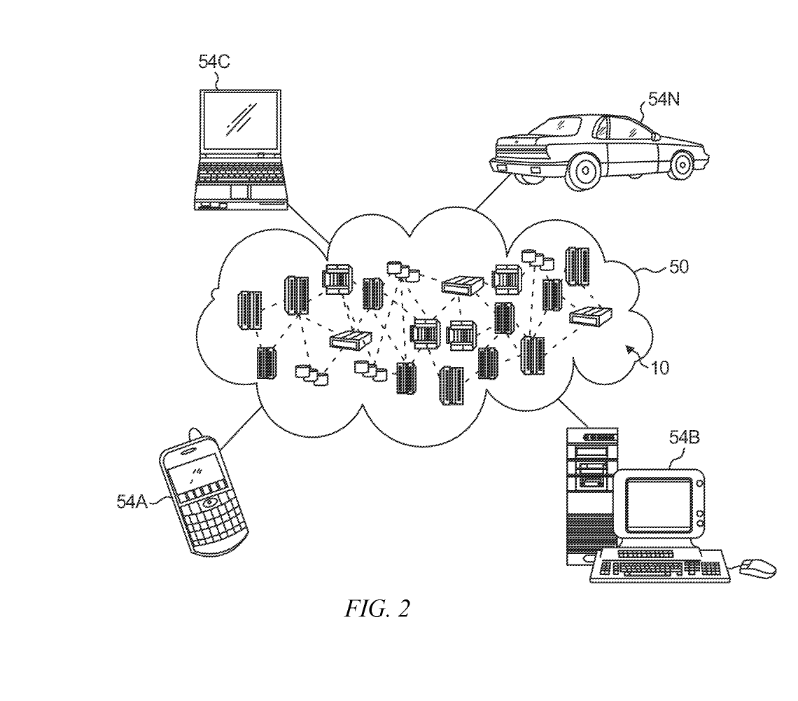

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

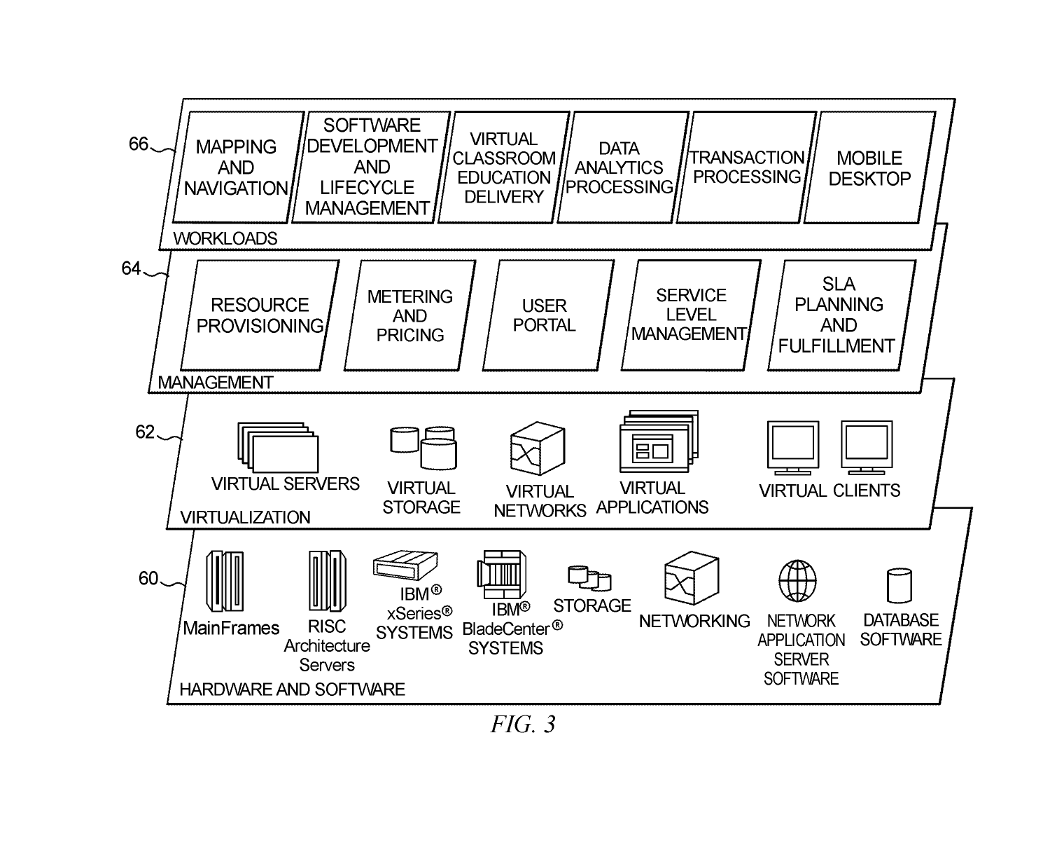

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided: Hardware and software layer 60 includes hardware and software components.

Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

Previous cluster management-related work in the desktop area has dealt with reliability and availability but has not reached into the desktop management functionality. Another category of related work is in the context of cluster management of interconnected computers that work together as a single system, where the main goal is to maintain the servers in manually-created clusters configured appropriately such that an application may reliably have work executed on them. In one or more embodiments of the present invention, the clusters are dynamically created for the purpose of automating common desktop management tasks.

As compared to the prior-art approach of deploying and maintaining desktops by incident management on a manual, case-by case or ticket-by-ticket basis, one or more embodiments of the present invention advantageously enable identification of desktop classes with similar characteristics given a management aspect, such as deployment, patching, incident and problem management. In one or more embodiments, operation optimization is based on classification of desktops with similar or complementary behavior models. Furthermore, one or more embodiments reduce the labor required to manage large deployments of desktops by enabling automation of common tasks. Advantageously, at least some instances enable target patches for dynamically identified desktops matching existing problems. One or more embodiments of the present invention can be leveraged in the context of cloud environments.

In one aspect of one or more embodiments of the present invention, desktop behavior models are generated based on their configuration, usage, performance, tickets or problems exposed when performing a particular management task or under normal operation. Desktops matching a behavior model are grouped and common tasks operated on those desktops are identified. Classes of desktop samples are created with complementary behavior models. For each class, common tasks are customized to optimize the management of the desktops based on the required optimization criteria, e.g., labor, cost, and/or time. One or more embodiments of the present invention preferably maintain, for the users, a dynamic set of classes by updating the classes depending on the evolution of their desktops' behavior models and the current issues. Furthermore, some instances provide “what if” simulation environments for testing of potential common tasks on newly identified classes. Dynamic representation of the classes can be nesting for problem determination. For instance, if all the issues are in the same geography or in the same business unit, it is easier for the administrator to see them grouped. If the issues are in the same country, they will be grouped by country. If the issues are in the same business unit, they will be grouped by business unit. As new class requirements are used in the system, one or more embodiments of the present invention preferably learn to maintain the dynamic classes for the new requirements. This results in a productivity increase by clustering so-called “lazy” users. Furthermore in this regard, a “lazy” user is one who takes a long time to update his or her environment—e.g., someone who does not promptly seek help for problems (say, by opening a ticket) or someone who does not download new or updated software when prompted. In one or more embodiments, such users are clustered separately so as to isolate “inherent” problems from problems caused by lack of diligence on the part of users.

Advantageously, one or more embodiments of the present invention implement the following methodology.
1. Build models of configuration, usage, performance, tickets or problems to generate classes of desktops
2. Dynamically monitor the evolution of the desktop affinity to classes
3. Take targeted action (patch, upgrade, application alignment).

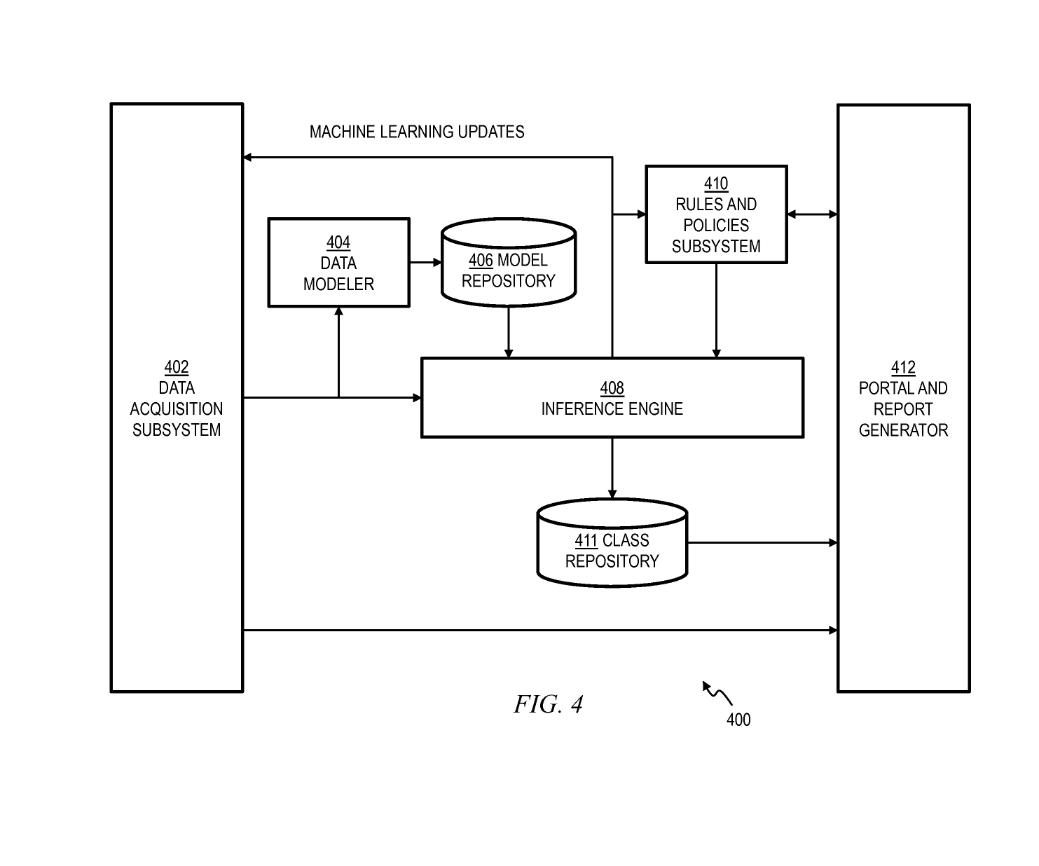

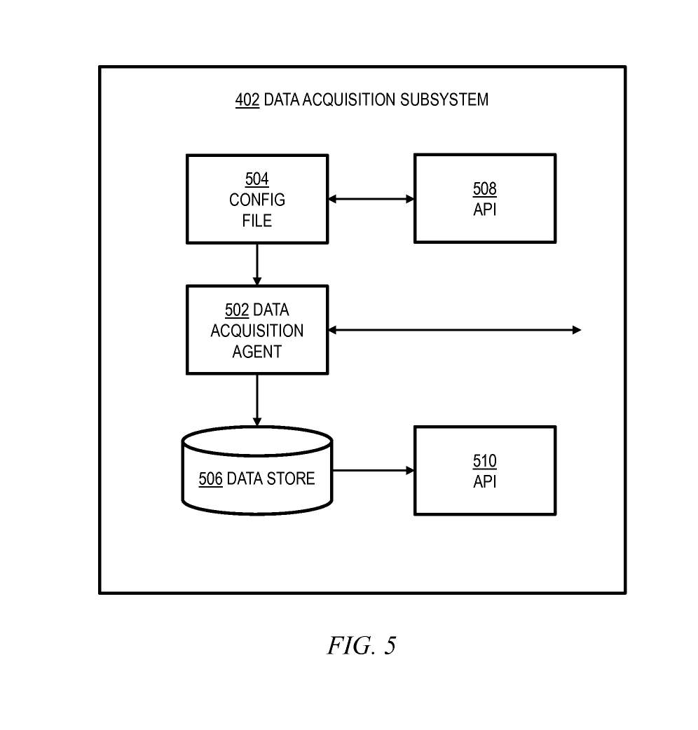

Referring to FIG. 4, in one or more embodiments, an on-line IT analytics managed system for class-based management 400 is provided. Data acquisition subsystem 402 maintains a rich source of information about the configuration, usage, performance, tickets or problems occurring in the enterprise environment. Referring to FIG. 5, the data acquisition subsystem preferably includes a data acquisition agent 502 designed to send notifications upon generation, a configuration file 504 which takes machine learning updates through an appropriate API (application programming interface) and a data store 506 where the collected information is stored and often aggregated in files, databases or asset management tools for real-time access by the user. A data modeler 404 analyzes the data (preferably in row or parsed form for security reasons) received from the data acquisition agent 502 to generate models to capture the typical behavior of the usage, performance, tickets or problems occurring in the enterprise environment. Typical modeling algorithms are grouping, K-nearest neighbor, support vector machines, regression, and auto-regression. A model repository 406 stores the behavior models in files, databases or asset management tools. These behavior models are updated as new data is generated in the environment.

The system 400 also preferably includes an inference engine 408 which takes action based on data it receives from the other subsystems, a rules and policies subsystem 410 which may include files, databases or asset management tools that store when and what actions are applied to the environment based on triggers detected by the inference engine 408, a class repository 411 which stores class information such as data models, frequency of incidents, rate of incidents, minimums, maximums, and typical values, and a portal and report generator 412 which displays results for the users preferably through a browser interface. Further regarding rules and policies subsystem 410, typical actions applied based on triggers detected by the inference engine 408 are management operations tasks: patch, upgrade, application alignment, etc. The rules can be inferred by mining the results of the executions triggered by the inference engine 408 and also maintained manually for online real-time access against the real-time data received from the data acquisition subsystem 402. After the model repository 406 is populated based on historical data, the inference engine 408 will preferably implement one or more of the following activities:
Detect the configuration items with abnormal behavior which, based on the ticketing rules of the rules and policies subsystem 410, may result in incident tickets and task actions;
Detect the configuration items with similar behavior and dynamically generate the classes of machines in the class repository 411 for an enhanced visualization of the environment in the portal and report generator 412, nesting the classes based on the relevance to the issue at hand;
Create and store, in the class repository 411, one or more classes of machine samples with complementary behavior, which can be used for test pilots.

In one or more embodiments, portal and report generator 412 displays the results of the inference engine's analysis for user consumption; the user can visualize a prioritized list of events with abnormal behavior and drill into the nested structure of machine classes organized dynamically depending on the selected issue or event.

As noted, in one or more embodiments, data acquisition subsystem 402 includes data acquisition agent 502, configuration file 504, and data store 506. Configuration file 504 is linked to inference engine 408 via API 508, while data store 506 is linked to portal and report generator 412 via API 510. API 508 is used to configure the data acquisition system, by allowing the inference engine 408 to drive modifications back into the data acquisition system (e.g., to cause the data acquisition system to collect more detailed or more specific information). API 510 allows portal and report generator 412 to pull detailed information from the data acquisition system. The APIs provide a linkage to allow programmatic interaction with other systems. Non-limiting examples of suitable API implementations include SOAP (Simple Object Access Protocol) and Representational State Transfer (REST). Data store 506 includes a file, database, and/or other data structure stored in a persistent memory device (e.g. hard disk or the like). Data acquisition agent may run, for example, on the individual desktop devices; partly on the individual desktop devices and partly on a central machine; or in another suitable manner. Suitable implementations include the SysTrack Platform available from Lakeside Software, Inc., Bloomfield Hills, Mich., USA; the open source Ganglia scalable distributed monitoring system for high-performance computing systems available on SOURCEFORGE; various monitoring options available in OpenStack open source cloud computing software; and IBM Tivoli® Monitoring Agents (registered mark; available for International Business Machines Corporation, Armonk, N.Y., USA).

Model repository 406 and class repository 411 each include a file, database, and/or other data structure stored in a persistent memory device (e.g. hard disk or the like). Data modeler 404 is a program which examines the raw data from a historical standpoint to find out global attributes of different metrics; for example, long term averages of CPU usage, and builds up models of machines and groups of machines. Both numeric and textual data can be addressed, as well as both structured and unstructured data. One non-limiting exemplary implementation uses the Weka collection of machine learning algorithms for data mining tasks from the University of Waikato in Hamilton, New Zealand. Other non-limiting exemplary implementations use one or more of time series analysis, natural language processing, correlation techniques, and text analysis to provide commonality among the entries and generate a model. Some embodiments use simple averages. Others employ neural networks wherein the nodes have coefficients defined in order to recognize, when something new is entered, what type of data it is. Any suitable program language can be used.

Inference engine 408 can be implemented, by way of example and not limitation, with a plurality of JAVA classes. Recall that models have been created from historical data and the models have been stored in repository 406. Rules and policies subsystem 410 includes rules and policies in a file, database, and/or other data structure stored in a persistent memory device (e.g. hard disk or the like), and/or an API to access such data located elsewhere. The actions just described are performed offline, in one or more embodiments. Then, at runtime, inference engine 408 obtains real-time data for the IT environment in question from data acquisition subsystem, 402, and runs same against the models and rules. A decision is made by engine 408 to infer where the new (real-time) data belongs, based on the models and rules. One non-limiting suitable inference technique for natural language processing of textual data includes data frequency. One non-limiting suitable inference technique for processing of numerical data (e.g., time series) includes obtaining a value for real-time data from the data acquisition subsystem, 402, and using the models to generate an estimated value (e.g. given the time of day and other data, predict 80% CPU usage; suppose the real-time data from the data acquisition subsystem, 402 shows 95% CPU usage). Compare the data to see the percent discrepancy (error). Suitable thresholds are used to determine whether the 95% CPU usage is in the same class as the predicted 80% CPU usage. If the threshold was, say, +/−16%, the 95% CPU usage is in the same class as the predicted 80% CPU usage. If the threshold was, say, +/−1%, the 95% CPU usage is not in the same class as the predicted 80% CPU usage.

Portal and report generator 412 can be, for example, a server that serves out html to a browser on a user machine; a server or other computer that permits the download of comma-separated values (csv) or other files to a user machine; and the like.

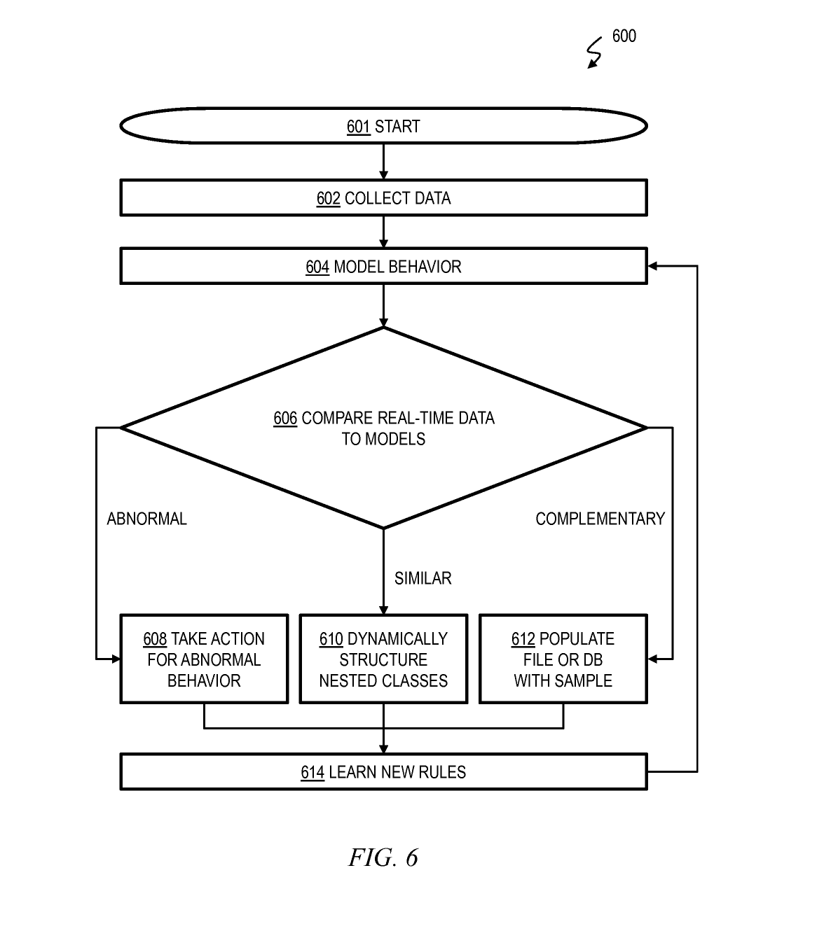

FIG. 6 shows a preferred workflow 600 of one or more embodiments of the present invention. The process begins at 601; step 602 includes collecting both historical and real-time data including but not limited to configuration data, performance data, usage data, monitoring data, and ticketing data. This step can be carried out, for example, with data acquisition subsystem 402. In step 604, typical behavior based on historical data generated in the enterprise environment is modelled by data modeler 404 and stored in the data modeler 406. Again, typical modeling algorithms that can be used are grouping, K-nearest neighbor, support vector machines, regression, and auto-regression. In step 606, real-time data that has been collected is compared, by the inference engine 408, with the stored models. If configuration items are detected with abnormal behavior, then the workflow proceeds to step 608 where action is taken such as execution of a task or opening of a ticket. If, in step 606, the configuration data (e.g. Linux vs. Windows) is determined to be similar to other stored behavior then the workflow proceeds to step 610 where the nested classes of machines are dynamically structured for user interface drill down visualization. If, in step 606, the configuration data indicates complimentary behavior of machine samples, then the process proceeds to step 612 where a file or database is populated with a heterogeneous sample of machines for test pilots and “what-if” analysis. After step 608, 610, or 612 as the case may be, it is preferable for the system to learn new rules in step 614 by mining the results of the executions triggered by the inference engine 408. The process then continues in step 604 where the models are updated based on the most recently collected data.

### Recapitulation

Given the discussion thus far, it will be appreciated that, in general terms, an exemplary method, according to an aspect of the invention, includes the step (part of 602) of collecting historical data about a plurality of computing resources (e.g., with data acquisition subsystem 402). A further step (also part of 602) includes collecting real-time data about the plurality of computing resources (e.g., with data acquisition subsystem 402). A further step 604 includes, based on the collected historical data, modeling typical behavior of the plurality of computing resources and storing resulting models in a model repository 406. This step can be carried out with the data modeler 404 and model repository 406. An even further step includes, with inference engine 408, comparing the real-time data to the models. Another step includes managing the plurality of computing resources based on the comparing step. This step can be carried out, at least in part, with the inference engine 408.

The computing resources can be, but need not be, desktop computing resources such as personal computers running Windows 7 or later, Linux Gnome, or OS X. However, one or more embodiments can also be used beyond the desktop environment; e.g., for servers, tablets, or any other computer system.

In some cases, the historical data and the real-time data include at least one of configuration data, performance data, usage data, monitoring data, and tickets.

In some cases, the modeling includes at least one of grouping, K-nearest neighbor, support vector machines, regression, and auto-regression.

In some cases (“abnormal” branch of decision block 606), the comparing step reveals configuration parameters (i.e., on one of the desktop or other computing resources, that need to be changed to correct the anomaly) with abnormal behavior, and the managing includes taking action for the abnormal behavior by at least one of executing a task and opening a new ticket, as at step 608. This is a new ticket opened in response to detecting the problem; not one of the tickets mentioned above. In one or more embodiments, engine 408 opens the ticket or initiates the action.

In some cases (“similar” branch of decision block 606), the comparing step includes classifying configuration parameters (as discussed just above) with similar behavior, and the managing includes dynamically structuring nested classes of the computing resources for user interface drill-down visualization, as at step 610. In one or more embodiments, engine 408 carries out at least a portion of the dynamic structuring.

In some cases (“complementary” branch of decision block 606), the comparing step includes generating classes of computing resource samples with complementary behavior, and the managing includes populating at least one of a file and a database with a heterogeneous sample of the computing resources for test pilots and what-if analysis. The computing resource samples are samples from the aforementioned computing resources, on which the test pilots and what-if analyses are to be conducted. In one or more embodiments, engine 408 carries out at least a portion of the file or database population.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 1, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 1) running a server program. It will be understood that such a physical server may or may not include a display and keyboard.

One or more embodiments are particularly significant in the context of a cloud or virtual machine environment, although this is exemplary and non-limiting. Reference is made back to FIGS. 1-3 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks in the figures; e.g., a data acquisition subsystem 402 (with its components shown in FIG. 5); a data modeler 404; a model repository 406, an inference engine 408; a rules and policies subsystem 410; a class repository 411 and a portal and report generator 412. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface to implement user interface aspects of the on-line IT analytics managed system for class-based management 400 is reporting provided through the portal and report generator 412, to a computing device of a user. Such a user interface can be implemented, for example, via hypertext markup language (HTML) code served out by a server or the like, to a browser of a computing device of a user. The HTML is parsed by the browser on the user's computing device to create a graphical user interface (GUI). Any number of techniques for generating web pages may be used.

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
collecting historical data about a plurality of computing resources;
collecting real-time data about said plurality of computing resources;
based on said collected historical data, modelling typical behavior of said plurality of computing resources and storing resulting models in a model repository;
with an inference engine, comparing said real-time data to said models; and
managing said plurality of computing resources based on said comparing step.

2. The method of claim 1, wherein said historical data and said real-time data comprise at least one of configuration data, performance data, usage data, monitoring data, and tickets.

3. The method of claim 2, wherein said modeling comprises at least one of grouping, K-nearest neighbor, support vector machines, regression, and auto-regression.

4. The method of claim 3, wherein said comparing step reveals configuration parameters with abnormal behavior, and wherein said managing comprises taking action for said abnormal behavior by at least one of executing a task and opening a new ticket.

5. The method of claim 3, wherein said comparing step comprises classifying configuration parameters with similar behavior, and wherein said managing comprises dynamically structuring nested classes of said computing resources for user interface drill-down visualization.

6. The method of claim 3, wherein said comparing step comprises generating classes of computing resource samples with complementary behavior, and wherein said managing comprises populating at least one of a file and a database with a heterogeneous sample of said computing resources for test pilots and what-if analysis.

7. The method of claim 1, wherein:
said collecting of said historical data is carried out with a data acquisition subsystem module, embodied in a non-transitory computer readable medium, executing on at least one hardware processor;
said collecting of said real-time data is carried out with said data acquisition subsystem module, embodied in said non-transitory computer readable medium, executing on said at least one hardware processor;
said modeling of said typical behavior is carried out, at least in part, with a data modeler module, embodied in said non-transitory computer readable medium, executing on said at least one hardware processor;
said comparing of said real-time data to said models is carried out with an inference engine module, embodied in said non-transitory computer readable medium, executing on said at least one hardware processor, which implements said inference engine; and
said managing of said plurality of computing resources is carried out, at least in part, with said inference engine module, embodied in said non-transitory computer readable medium, executing on said at least one hardware processor.

8. An apparatus comprising:
a memory; and
at least one processor, coupled to said memory, and operative to:
collect historical data about a plurality of computing resources;
collect real-time data about said plurality of computing resources;
based on said collected historical data, model typical behavior of said plurality of computing resources and store resulting models in a model repository;
implement an inference engine which compares said real-time data to said models; and
manage said plurality of computing resources based on said comparing step.

9. The apparatus of claim 8, wherein said historical data and said real-time data comprise at least one of configuration data, performance data, usage data, monitoring data, and tickets.

10. The apparatus of claim 9, wherein said at least one processor is operative to model via at least one of grouping, K-nearest neighbor, support vector machines, regression, and auto-regression.

11. The apparatus of claim 10, wherein said comparing by said at least one processor reveals configuration parameters with abnormal behavior, and wherein said at least one processor is operative to manage by taking action for said abnormal behavior by at least one of executing a task and opening a new ticket.

12. The apparatus of claim 10, wherein said comparing by said at least one processor comprises classifying configuration parameters with similar behavior, and wherein said at least one processor is operative to manage by dynamically structuring nested classes of said computing resources for user interface drill-down visualization.

13. The apparatus of claim 10, wherein said comparing by said at least one processor comprises generating classes of computing resource samples with complementary behavior, and wherein said at least one processor is operative to manage by populating at least one of a file and a database with a heterogeneous sample of said computing resources for test pilots and what-if analysis.

14. The apparatus of claim 8, wherein said memory stores a plurality of distinct software modules including a data acquisition subsystem module, a data modeler module, and an inference engine module which implements said inference engine, and wherein:
said at least one processor is operative to collect said historical data by executing said data acquisition subsystem module;
said at least one processor is operative to collect said real-time data by executing said data acquisition subsystem module;
said at least one processor is operative to model said typical behavior, at least in part, by executing said data modeler module;
said at least one processor is operative to compare said real-time data to said models by executing said inference engine module; and
said at least one processor is operative to manage said plurality of computing resources, at least in part, by executing said inference engine module.

15. A non-transitory computer readable medium comprising computer executable instructions which when executed by a computer cause the computer to perform the method of:
collecting historical data about a plurality of computing resources;
collecting real-time data about said plurality of computing resources;
based on said collected historical data, modeling typical behavior of said plurality of computing resources and storing resulting models in a model repository;
with an inference engine, comparing said real-time data to said models; and
managing said plurality of computing resources based on said comparing step.

16. The non-transitory computer readable medium of claim 15, wherein said historical data and said real-time data comprise at least one of configuration data, performance data, usage data, monitoring data, and tickets.

17. The non-transitory computer readable medium of claim 16, wherein said modeling comprises at least one of grouping, K-nearest neighbor, support vector machines, regression, and auto-regression.

18. The non-transitory computer readable medium of claim 17, wherein said comparing step reveals configuration parameters with abnormal behavior, and wherein said managing comprises taking action for said abnormal behavior by at least one of executing a task and opening a new ticket.

19. The non-transitory computer readable medium of claim 17, wherein said comparing step comprises classifying configuration parameters with similar behavior, and wherein said managing comprises dynamically structuring nested classes of said computing resources for user interface drill-down visualization.

20. The non-transitory computer readable medium of claim 17, wherein said comparing step comprises generating classes of computing resource samples with complementary behavior, and wherein said managing comprises populating at least one of a file and a database with a heterogeneous sample of said computing resources for test pilots and what-if analysis.
